(19) United States
(12) Patent Application Publication
(10) Pub. No.: US 2016/0349115 A1
(43) Pub. Date: Dec. 1, 2016

(54) TEMPERATURE ESTIMATION METHOD OF HIGH TEMPERATURE MEMBER, CONTENT ESTIMATION METHOD OF TETRAGONAL-PRIME PHASE, AND DETERIORATION DETERMINATION METHOD

(71) Applicant: MITSUBISHI HEAVY INDUSTRIES, LTD., Tokyo (JP)

(72) Inventors: Ruifen WU, Tokyo (JP); Taiji TORIGOE, Tokyo (JP); Ichiro NAGANO, Tokyo (JP); Yoshifumi OKAJIMA, Tokyo (JP); Yasuhiko TSURU, Tokyo (JP)

(21) Appl. No.: 14/892,090

(22) PCT Filed: Feb. 5, 2015
(86) PCT No.: PCT/JP2015/053233

§ 371 Date: Nov. 18, 2015

(30) Foreign Application Priority Data
Nov. 12, 2014 (JP) 2014-229619

(51) Int. Cl. G01J 5/10

(52) U.S. Cl. CPC G01J 5/10

(57) ABSTRACT

A temperature estimation method includes the steps of measuring a content of a tetragonal-prime phase included in a coating layer formed on a surface of a high temperature member by X-ray diffraction or Rietveld analysis, Raman spectroscopy, or the like; and estimating a surface temperature of the high temperature member based on the estimated content of the tetragonal-prime phase.

### TECHNICAL FIELD

The present invention relates to a temperature estimation method of a high temperature member, a content estimation method of a tetragonal-prime phase, and a deterioration determination method.

This application is based on and claims priority from Japanese Patent Application No. 2014-229619 filed on Nov. 12, 2014, the contents of which are incorporated herein by reference.

### BACKGROUND ART

In an industrial gas turbine, the demand for high efficiency and high temperature resistance is rapidly increasing, and the importance of a thermal barrier coating (TBC) provided to a high temperature member is also increasing. For example, in order to secure reliability of the TBC, a technique for estimating a surface temperature of the TBC exposed to high temperatures is desired. For example, PTL 1 discloses a temperature estimation method for estimating the amount of an M phase (monoclinic phase) included in a TBC using X-ray diffraction and calculating a surface temperature of the TBC based on the measured amount of monoclinic phase.

The TBC is configured by tough crystals called a T′ phase (tetragonal-prime phase) in an initial stage. However, if the TBC is exposed at a certain high temperature for a long period of time, the T′ phase of the TBC is decomposed into a T phase (tetragonal phase) and a C phase (cubic phase). Then, if the TBC is cooled, the T phase (tetragonal phase) is converted into an M phase (monoclinic phase) to cause volume expansion and reduce fracture toughness. The method disclosed in PTL 1 is a temperature estimation method based on the content of the monoclinic phase (M phase).

### CITATION LIST

### Patent Literature

[PTL 1] Japanese Patent No. 3519703

### SUMMARY OF INVENTION

### Technical Problem

It is known that the reason why the T′ phase is decomposed into the T phase and the C phase in such a crystalline structure change process is greatly related to temperature. The method disclosed in PTL 1 is based on the content of the monoclinic phase (M phase) generated after the temperature of the TBC is lowered, but in consideration of the content of the T′ phase, it is considered that if it is possible to check the degree of decomposition of the T′ phase included in the TBC, and to estimate the temperature based on the content of the T′ phase, the surface temperature of the TBC can be estimated more precisely. However, such a temperature estimation method has not been proposed up to now.

The invention provides a temperature estimation method, a content estimation method of a tetragonal-prime phase, and a deterioration determination method capable of solving the above-mentioned problems.

### Solution to Problem

According to a first aspect of the invention, there is provided a temperature estimation method including the steps of: measuring a content of a tetragonal-prime phase included in a coating layer formed on a surface of a high temperature member by X-ray diffraction or Raman spectroscopy; and estimating a surface temperature of the high temperature member based on the estimated content of the tetragonal-prime phase.

According to a second aspect of the invention, the above-described temperature estimation method includes the steps of: performing Rietveld analysis with respect to each of diffraction results obtained by performing measurement based on the X-ray diffraction with respect to a plurality of test members of the coating layer heated at each of a plurality of predetermined heating temperatures for a plurality of predetermined heating times and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of test members, accumulating data on a heating temperature, a heating time, and the content of the tetragonal-prime phase corresponding to each test member, and calculating a relational expression between the heating time, the heating temperature, and the content of the tetragonal-prime phase for the test member; performing, when the heating time in the heating is known with respect to a measurement member of the coating layer heated at a heating temperature of a predetermined temperature or higher, the Rietveld analysis with respect to the diffraction results based on the X-ray diffraction with respect to the measurement members and the diffraction result based on the X-ray diffraction with respect to the member for which the contents of the tetragonal-prime phase, the tetragonal phase, and the cubic phase are known in advance to calculate the content of the tetragonal-prime phase included in each measurement member; and calculating the heating temperature of the measurement member based on the heating time of the measurement member, the calculated content of the tetragonal-prime phase included in the measurement member, and the relational expression.

According to a third aspect of the invention, the above-described temperature estimation method includes the steps of: performing Rietveld analysis with respect to each of diffraction results obtained by performing measurement based on the X-ray diffraction with respect to a plurality of test members of the coating layer heated at each of a plurality of predetermined heating temperatures for a plurality of predetermined heating times and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of test members, accumulating data on a heating temperature, a heating time, and the content of the tetragonal-prime phase corresponding to each test member, and calculating a relational expression between the heating time, the heating temperature, and the content of the tetragonal-prime phase for the test member; calculating a correlation between a feature amount of a spectrum in a result obtained by measuring the plurality of test members using the Raman spectroscopy and the calculated content of the tetragonal-prime phase included in each test member; calculating, when the heating time in the heating is known with respect to the measurement member of the coating layer heated at a heating temperature of a predetermined temperature or higher, the content of the tetragonal-prime phase included in the measurement member based on the feature amount of the spectrum obtained by measuring the measurement member using the Raman spectroscopy and the correlation; and calculating the heating temperature of the measurement member based on the heating time of the measurement member, the calculated content of the tetragonal-prime phase included in the measurement member, and the relational expression.

According to a fourth aspect of the invention, in the above-described temperature estimation method, the relational expression is based on a linear relationship between a decomposition amount of the tetragonal-prime phase and ¼ powers of the heating time.

According to a fifth aspect of the invention, there is provided a content measurement method of a tetragonal-prime phase, for measuring a content of a tetragonal-prime phase included in a coating layer formed on a surface of a high temperature member, including the step of: performing Rietveld analysis with respect to each of diffraction results obtained by performing measurement based on X-ray diffraction with respect to the measurement members of the coating layer heated at a heating temperature of a predetermined temperature or higher and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of measurement members.

According to a sixth aspect of the invention, there is provided a content measurement method of a tetragonal-prime phase, for measuring a content of a tetragonal-prime phase included in a coating layer formed on a surface of a high temperature member, including the steps of: performing Rietveld analysis with respect to each of diffraction results obtained by performing measurement based on the X-ray diffraction with respect to a plurality of test members of the coating layer heated at each of a plurality of predetermined heating temperatures for a plurality of predetermined heating times and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of test members; calculating a correlation between a feature amount of a spectrum in a result obtained by measuring the plurality of test members using the Raman spectroscopy and the calculated content of the tetragonal-prime phase included in each test member; and calculating, when the heating time in the heating is known with respect to the measurement member of the coating layer heated at a heating temperature of a predetermined temperature or higher, the content of the tetragonal-prime phase included in the measurement member based on the feature amount of the spectrum obtained by measuring the measurement member using the Raman spectroscopy and the correlation.

According to a seventh aspect of the invention, there is provided a deterioration determination method including the steps of: calculating the content of the tetragonal-prime phase included in the measurement member by the content measurement method of the tetragonal-prime phase described above; and calculating a deterioration degree of the high temperature member based on a predetermined correspondence relationship between the content of the tetragonal-prime phase included in the measurement member and the deterioration degree of the high temperature member.

### Advantageous Effects of Invention

According to the above-described temperature estimation method, it is possible to estimate a surface temperature of a high temperature member.

### BRIEF DESCRIPTION OF DRAWINGS

FIG. 1 is a diagram schematically illustrating a high temperature member according to a first embodiment of the invention.

FIG. 2 is a diagram illustrating a change in a crystalline structure of a TBC of the high temperature member according to the first embodiment of the invention.

FIG. 3 is a first diagram illustrating derivation of a relational expression between the content of a T′ phase, a heating time, and a TBC surface temperature in the first embodiment of the invention.

FIG. 4 is a second diagram illustrating derivation of a relational expression between the content of a T′ phase, a heating time, and a TBC surface temperature in the first embodiment of the invention.

FIG. 5 is a third diagram illustrating derivation of a relational expression between the content of a T′ phase, a heating time, and a TBC surface temperature in the first embodiment of the invention.

FIG. 6 is a fourth diagram illustrating derivation of a relational expression between the content of a T′ phase, a heating time, and a TBC surface temperature in the first embodiment of the invention.

FIG. 7 is a flowchart illustrating a surface temperature estimation method of a TBC according to the first embodiment of the invention.

FIG. 8 is a diagram illustrating the relationship between the position of a Raman peak and the content of a T′ phase according to a second embodiment of the invention.

FIG. 9 is a diagram illustrating the relationship between a full width at half maximum of a Raman peak and the content of a T′ phase according to the second embodiment of the invention.

FIG. 10 is a diagram illustrating the relationship between an intensity ratio of Raman peaks and the content of a T′ phase according to the second embodiment of the invention.

FIG. 11 is a flowchart illustrating a surface temperature estimation method of a TBC according to the second embodiment of the invention.

FIG. 12 is a diagram illustrating the relationship between the position of a Raman peak and an LMP value according to a third embodiment of the invention.

FIG. 13 is a diagram illustrating the relationship between a full width at half maximum of a Raman peak and an LMP value according to the third embodiment of the invention.

FIG. 14 is a diagram illustrating the relationship between an intensity ratio of Raman peaks and an LMP value according to the third embodiment of the invention.

### DESCRIPTION OF EMBODIMENTS

### First Embodiment

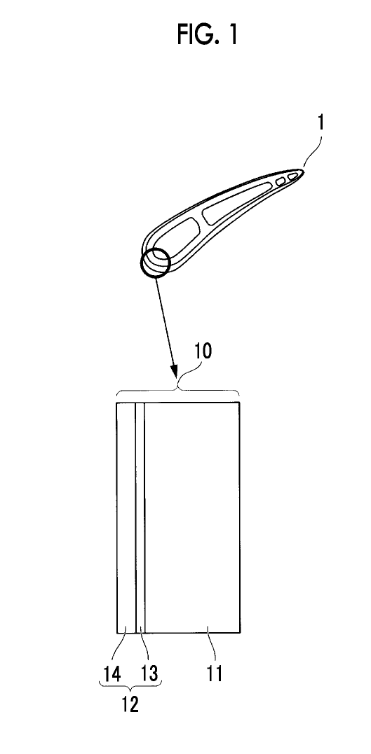

Hereinafter, a control system according to a first embodiment of the invention will be described with reference to FIGS. 1 to 6.

FIG. 1 is a diagram schematically illustrating a high temperature member according to a first embodiment of the invention.

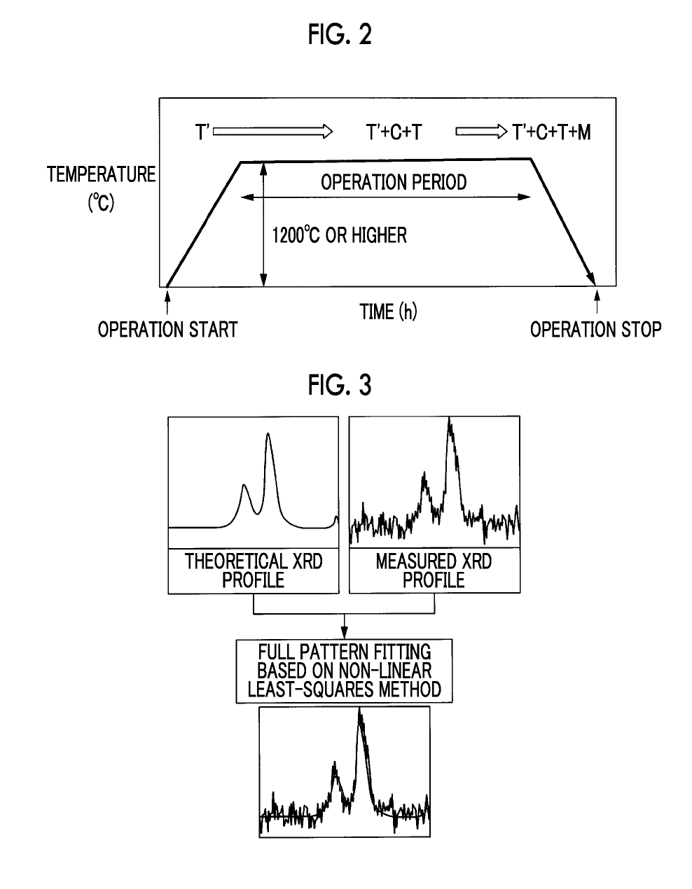

FIG. 2 is a diagram illustrating a change in a crystalline structure of a top coat layer of the high temperature member according to the first embodiment of the invention.

A thermal barrier coating (TBC) is applied to a high temperature member exposed at a high temperature, such as a rotor-stator blade, a separation ring or a combustor of a gas turbine, by flame-spraying a flame coating material having a low thermal conductivity (for example, a ceramic-based material having a low thermal conductivity) on a surface of a heat-resistant alloy layer which is a base material in order to improve thermal insulation properties and durability. In FIG. 1, a turbine wing 1 is configured by a high temperature member 10. The high temperature member 10 is formed by a base material 11 made of a heat-resistant alloy, and a thermal barrier coating (TBC) layer 12. Further, the thermal barrier coating layer 12 is formed by a bond coat layer 13 made of metal for improvement of adhesion and oxidation resistance with respect to the base material 11, and a top coat layer 14 made of ceramics for improvement of the heat insulation properties. FIG. 2 shows a state where a crystalline structure of yttria stabilized zirconia (YSZ) of the top coat layer is changed over an operation time of a gas turbine when the YSZ is used as an example of the top coat layer.

The flame-sprayed YSZ includes tough crystals called a T′ phase (tetragonal-prime phase) generated by being rapidly cooled, which occupy almost 100% of its content. Accordingly, almost the entirety of the YSZ when an operation of the gas turbine is started is occupied by the T′ phase. The T′ phase is relatively stabilized, but when exposed at a high temperature that exceeds 1200° C., the T′ phase is gradually decomposed into a T phase (tetragonal phase) and a C phase (cubic phase). Accordingly, during the operation time of the gas turbine, a phenomenon where the T′ phase is decomposed into the T phase and the C phase occurs, and thus, the T′ phase, the T phase, and the C phase are mixedly present in the YSZ of the top coat layer 14 formed on the surface of the high temperature member 10. Further, the T phase is stabilized at the high temperature, but when cooled at a temperature of about 600° C. or lower, the T phase is decomposed into an M phase (monoclinic phase) and a C phase. Accordingly, when the operation time of the gas turbine is terminated and the operation is stopped, the YSZ is gradually cooled, and the T phase is decomposed. Thus, the YSZ when the operation is stopped is in a state where the T′ phase, the T phase, the M phase, and the C phase are mixedly present. It is known that a cooling speed at that time affects the decomposition of the T phase into the M phase and the C phase. Since the surface temperature of the top coat layer 14 of the turbine wing 1 is also related to a cooling method or the like of the turbine wing 1, for example, the surface temperature is very useful information in design of the gas turbine, and it is important to obtain as precise a temperature as possible. For example, when the surface temperature of the TBC is estimated by the content of the T phase or M phase, since the content is affected by the cooling speed of the turbine, it may be difficult to estimate a precise temperate at a high temperature. On the other hand, if it is possible to estimate the surface temperature of the top coat layer 14 when the gas turbine is operated based on the content (residue) of the T′ phase, since the content of the T′ phase is not affected by the cooling speed of the turbine or the like, for example, it is possible to more precisely estimate the surface temperature of the TBC. In this embodiment, a method for estimating the surface temperature of the top coat layer 14 in heating based on the content of the T′ phase is provided. Hereinafter, the surface temperature of the top coat layer 14 is referred to as a TBC surface temperature.

FIG. 3 is a first diagram illustrating derivation of a relational expression between the content of a T′ phase, a heating time, and a TBC surface temperature in the first embodiment of the invention.

FIG. 3 is a diagram illustrating creation of a database for identifying the content of the T′ phase included in the top coat layer 14. As described above, in this embodiment, the TBC surface temperature is estimated based on the content of the T′ phase included in the top coat layer 14. Accordingly, it is important to precisely know the content of the T′ phase of the TBC which is a measurement target. To this end, in this embodiment, a database is prepared using test pieces of the top coat layer 14 exposed to various temperatures for various amounts of time as samples. First, a heating process for heating the test pieces of the top coat layer 14 having the same composition as in an actual machine at a predetermined temperature for a predetermined time is performed. The predetermined temperature is 1100° C., 1200° C., 1300° C., 1400° C., or the like, for example. The predetermined time is 100 hours, 1000 hours, 10000 hours, or the like, for example. Then, measurement based on X-ray diffraction is performed with respect to each of the test pieces for which the heating process is performed under the various conditions to accumulate diffraction results [measured X-ray diffraction (XRD) profiles]. Here, it is preferable that a T′ phase, a T phase, an M phase and a C phase which are included in the test piece can be identified by the measurement result based on the X-ray diffraction, but with respect to the T′ phase, the T phase, and the C phase, lattice constants are close to each other and peaks of the measurement results are overlapped, and thus, it is difficult to identify the T′ phase, the T phase, and the C phase. Accordingly, the T′ phase, the T phase, and the C phase of the test piece are identified by Rietveld analysis.

In the Rietveld analysis, a measured XRD profile of each test piece and a theoretical XRD profile which is prepared in advance are analyzed by full pattern fitting or the like based on a non-linear least-squares method, for example, to thereby obtain a theoretical XRD profile for more precise fitting. The theoretical XRD profile is a theoretical value of diffraction result based on the X-ray diffraction generated by assuming various patterns of the contents of the T′ phase, the T phase, and the C phase and performing a simulation or the like for each pattern. As a result of the Rietveld analysis, if the theoretical XRD profile for fitting is determined, the contents of the T′ phase, the T phase, and the C phase of the test piece are determined as the contents of the T′ phase, the T phase, and the C phase assumed with respect to the determined theoretical XRD profile.

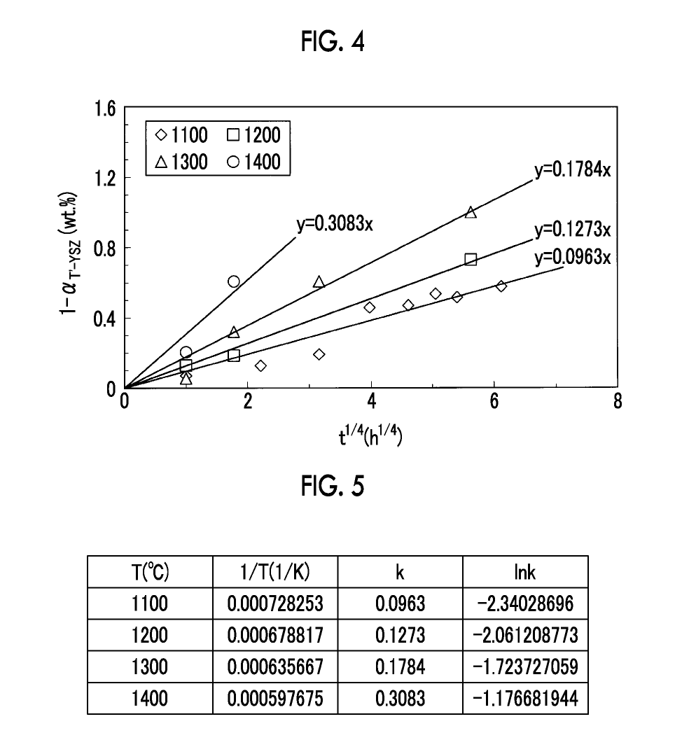

Next, a result obtained from the above experiment using an actual test piece will be described with reference to FIGS. 4 to 6.

FIG. 4 is a second diagram illustrating derivation of a relational expression between the content of a T′ phase, a heating time, and a TBC surface temperature according to the first embodiment of the invention.

FIG. 5 is a third diagram illustrating derivation of a relational expression between the content of a T′ phase, a heating time, and a TBC surface temperature according to the first embodiment of the invention.

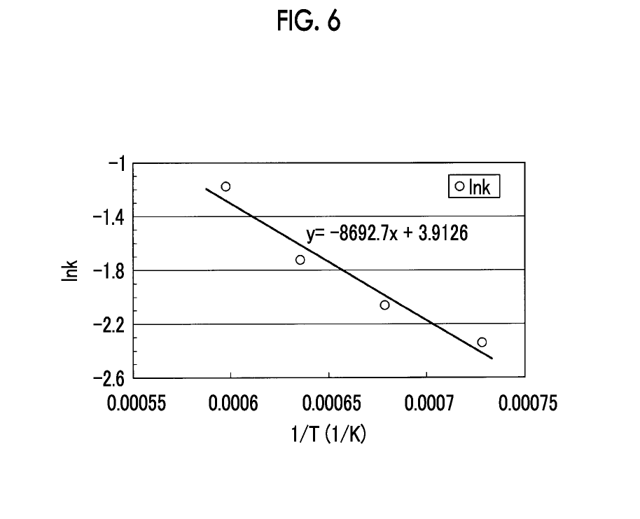

FIG. 6 is a fourth diagram illustrating derivation of a relational expression between the content of a T′ phase, a heating time, and a TBC surface temperature according to the first embodiment of the invention.

FIG. 4 shows a relationship between a decomposition amount of the T′ phase and a heating time according to the first embodiment of the invention.

In FIG. 4, a longitudinal axis (1−α_{T′-YSZ}) represents the decomposition amount of the T′ phase included in a test piece. A transverse axis represents a value of ¼ powers of the time (t) when the test piece is heated. Further, rhombus points represent data on a test piece which is heated at a temperature of 1100° C., square points represent data on a test piece which is heated at a temperature of 1200° C., triangular points represent data on a test piece which is heated at a temperature of 1300° C., and circular points represent data on a test piece which is heated at a temperature of 1400° C. As shown in FIG. 4, at the respective temperatures of 1100° C. to 1400° C., the decomposition amount (reduction amount) of the T′ phase due to the heating and the value of ¼ powers of the heating time (t) are in a linear relationship. At each temperature, when the slope of the straight line is k, the decomposition amount of the T′ phase and the value of ¼ powers of the heating time (t) may be expressed as follows.

f=1−α_{T′-YSZ}=kt^{1/4} (1)

FIG. 5 is a diagram illustrating a table in which values of a heating temperature (T) and the slope k in the above-mentioned expression (1) are collected. In the table shown in FIG. 5, T, 1/T, k, and ln k are sequentially written from the left. Here, 1/T represents an inverse number of an absolute temperature (unit: K) of T. ln k represents logₑ k. If 1/T and ln k in the table shown in FIG. 5 are plotted (Arrhenius plotting), a result shown in FIG. 6 is obtained. As shown in FIG. 6, a linear relationship is obtained between ln k and 1/T. If Expression (1) is arranged by an Arrhenius's equation, the following Expression (2) is obtained.

$$f = 1 - {α}_{{T}^{′} - YSZ} = {k}_{0} \cdot {e}^{\frac{- Q}{RT}} \cdot {t}^{1 / 4} \qquad ( 2 )$$

Further, if a linear equation that satisfies the relationship between 1/T and ln k is calculated, the following Expression (3) is obtained from FIG. 6.

y=−8692.7x+3.9126 (3)

Further, it is possible to calculate k₀=50.0 and Q=7.2×10⁵ J/mol from a segment of ln k₀=3.9126 and a slope of Q/R=−8692.7 (R is a gas constant: 8.31 J/(mol·k)). If these values are substituted in Expression (2), the following Expression (4) is obtained.

$$f = 1 - {α}_{{T}^{′} - YSZ} = 50 \cdot {e}^{\frac{- 7.2 \times {10}^{5}}{RT}} \cdot {t}^{1 / 4} \qquad ( 4 )$$

Here, when considering estimation of the TBC surface temperature of the actual machine, since the heating time (that is, a gas turbine operation time) t and the gas constant R are already known, if the content of the T′ phase (α_{T′-YSZ}) can be obtained, the heating temperature (T) can be calculated using Expression (4). Since the heating time (T) is a temperature of a furnace when a test piece of a top coat layer is inserted into the furnace, for example, the heating temperature (T) may be considered as the TBC surface temperature in the actual machine. That is, if the content of the T′ phase included in the top coat layer 14 of the actual machine can be obtained, it is possible to obtain the TBC surface temperature using Expression (4).

The above processes correspond to processes in a preparation stage of this embodiment. That is, in the preparation stage, data in which the measured XRD profiles of the respective test pieces which are heated under the various conditions described with reference to FIG. 3 and the contents of the T′ phase, the T phase, and the C phase (particularly, the content of the T′ phase) with respect to each of the heated test pieces are associated with each other is obtained, and also, the relational expression (Expression (4)) between the content of the T′ phase, the heating time, and the TBC surface temperature described with respect to FIGS. 4 to 6 is obtained.

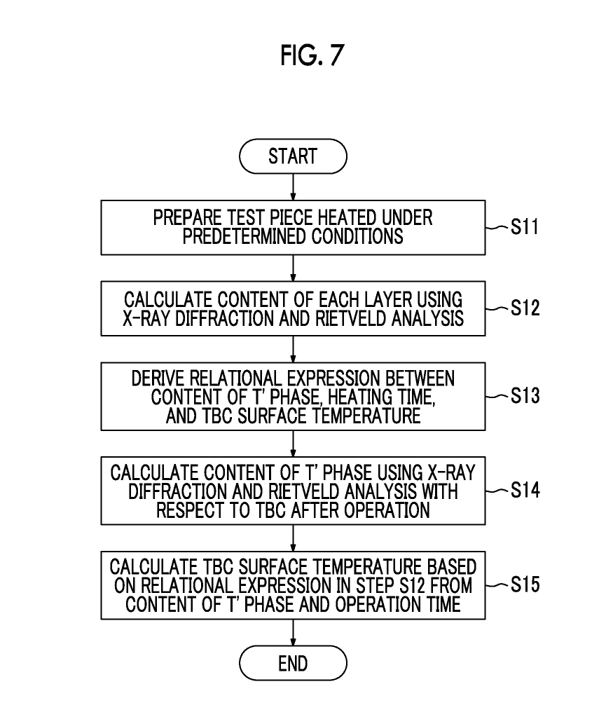

Next, a method for estimating a TBC surface temperature of the high temperature member 10 of an actual machine will be described with reference to FIG. 7.

FIG. 7 is a flowchart illustrating a TBC surface temperature estimation method according to the first embodiment of the invention.

Steps S11 to S13 are processes in a preparation stage. Since these processes are the same as described above, description thereof will be briefly made. First, plural test pieces of the top coat layer 14 are prepared, and each test piece is heated at a predetermined temperature for a predetermined time to form a heated test piece (step S11). Then, measurement based on X-ray diffraction is performed with respect to each test piece, a T′ phase, a T phase, a C phase, and an M phase are identified from diffraction patterns in a diffraction result, and the content of each phase is calculated. Here, since it is difficult to identify the T′ phase, the T phase, and the C phase using the X-ray diffraction, the content of each of these phases is calculated by the Rietveld analysis using a theoretical diffraction result (theoretical XRD profile) with respect to various patterns of the contents of the T′ phase, the T phase, and the C phase (step S12). Then, the relational expression between the content of the T′ phase, the heating time, and the TBC surface temperature during heating is derived in the order described using FIGS. 3 to 6 (step S13).

Then, estimation of the TBC surface temperature of the actual machine is performed. First, a TBC (top coat layer) which is a measurement target is obtained from a gas turbine after operation. Similar to step S12, X-ray diffraction and Rietveld analysis are performed with respect to the obtained measurement target TBC. In the Rietveld analysis, a target to be fitted for a measurement result based on the X-ray diffraction of the measurement target TBC may be a diffraction result based on the X-ray diffraction of the test piece analyzed in step S12 or may be a theoretical XRD profile as long as the contents of the T′ phase, the T phase and the C phase are known. Thus, the content of the T′ phase in the measurement target TBC is calculated (step S14).

Then, the content of the T′ phase calculated in step S14 and the operation time of the gas turbine are substituted in the relational expression [for example, Expression (4)] between the content of the T′ phase, the heating time, and the TBC surface temperature calculated in step S13. It is assumed that the operation time of the gas turbine is already known. The expression after substitution is solved for the TBC surface temperature (T) to calculate the TBC surface temperature (step S15). The calculated value is an estimated value of the surface temperature of the top coat layer 14 during operation of the gas turbine according to this embodiment.

According to this embodiment, it is possible to precisely calculate the content of the T′ phase in the top coat layer 14 using the X-ray diffraction and the Rietveld analysis. Further, it is possible to calculate the relational expression [for example, Expression (4)] between the content of the T′ phase, the heating time, and the TBC surface temperature from the fact that the T′ phase is decomposed into a stable T phase due to a diffusion phenomenon under a high temperature environment, the fact that a decomposition speed at that time is changed according to temperature, the fact that a reduction amount of the T′ phase at each temperature and ¼ powers of the TBC heating time is in a linear relationship (FIG. 4), and Arrhenius's equation [k=A×exp(−Q/RT), A: constant, Q: active energy, R: gas constant, T: absolute temperature]. Thus, it is possible to estimate the temperature of the TBC layer based on only the content of the T′ phase. Accordingly, it is possible to estimate a high surface temperature with high accuracy without being influenced by the cooling speed or the like of the gas turbine, for example.

### Second Embodiment

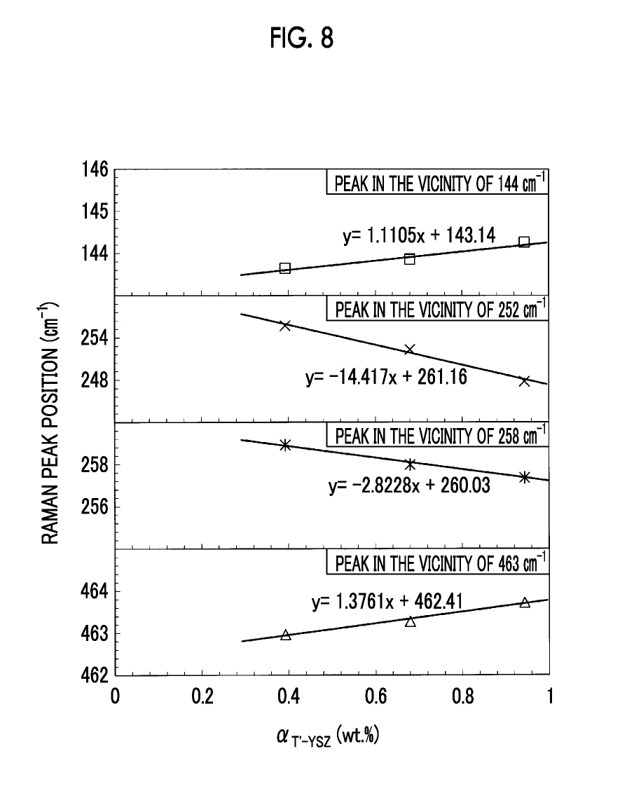

Hereinafter, a temperature estimation method according to a second embodiment of the invention will be described with reference to FIGS. 8 to 11.

In the second embodiment, when calculating the content of a T′ phase of the TBC which is a measurement target, measurement based on Raman spectroscopy is performed. In this embodiment, first, similar to the first embodiment, X-ray diffraction and Rietveld analysis are performed with respect to test pieces having the same composition as in an actual machine, heated under various conditions, and the content of the T′ phase in each test piece is calculated. Then, the measurement based on the Raman spectroscopy is performed with respect to each test piece for which the content of the T′ phase is known. A measurement result based on the Raman spectroscopy and the content of the T′ phase are recorded in association with each other.

Next, a result obtained by performing the measurement based on the Raman spectroscopy using an actual test piece will be described with reference to FIGS. 8 to 11.

FIG. 8 is a diagram illustrating the relationship between the position of a Raman peak and the content of the T′ phase in the second embodiment of the invention.

In FIG. 8, a longitudinal axis represents the position of a Raman peak, and a transverse axis represents the content of the T′ phase. In consideration of Raman peaks which are positioned in the vicinity of 144 cm⁻¹, 252 cm⁻¹, 258 cm⁻¹, and 463 cm⁻¹, if the relationship between the positions of these Raman peaks and the content of the T′ phase is arranged, a linear relationship as shown in FIG. 8 is obtained.

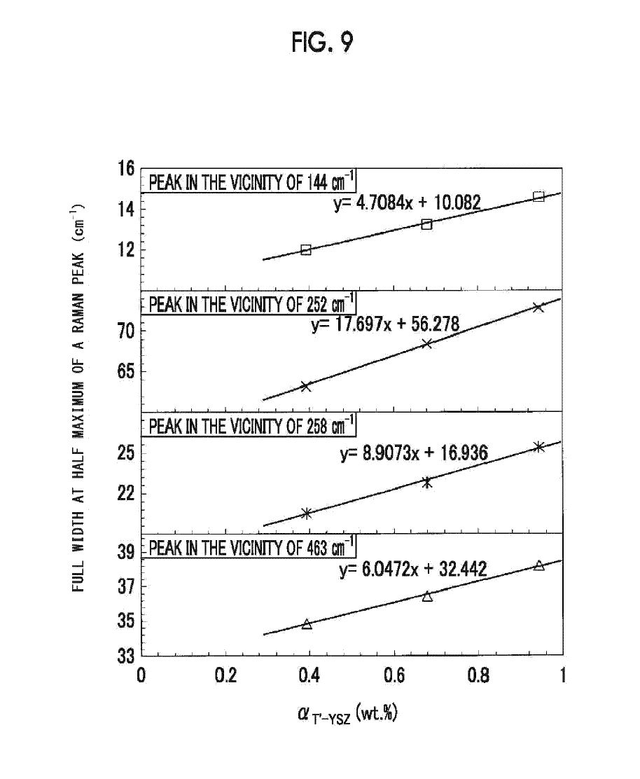

FIG. 9 is a diagram illustrating the relationship between a full width at half maximum of a Raman peak and the content of the T′ phase in the second embodiment of the invention.

In FIG. 9, a longitudinal axis represents a full width at half maximum of a Raman peak, and a transverse axis represents the content of the T′ phase. Similar to FIG. 8, in consideration of Raman peaks which are positioned in the vicinity of 144 cm⁻¹, 252 cm⁻¹, 258 cm⁻¹, and 463 cm⁻¹, if the relationship between the full width at half maximums of these Raman peaks and the content of the T′ phase is arranged, a linear relationship as shown in FIG. 9 is obtained.

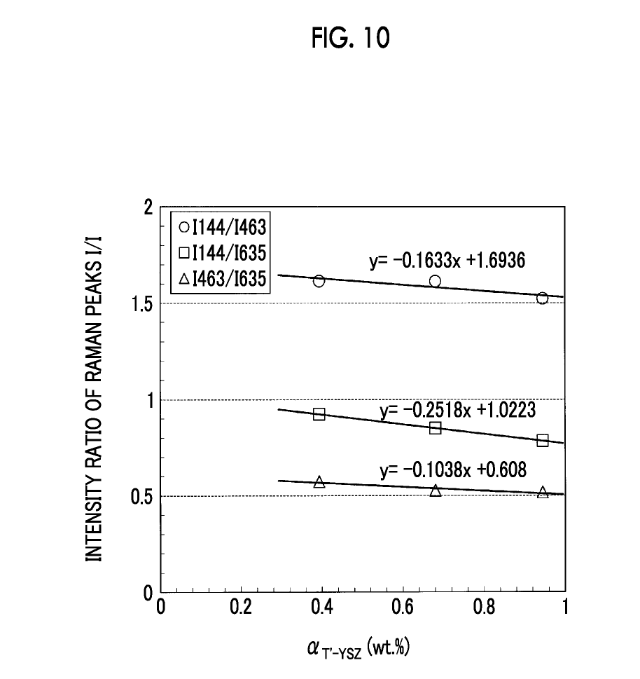

FIG. 10 is a diagram illustrating the relationship between the intensity ratio of Raman peaks and the content of the T′ phase in the second embodiment of the invention.

In FIG. 10, a longitudinal axis represents the intensity ratio of Raman peaks, and a transverse axis represents the content of the T′ phase. In consideration of the ratio of a peak intensity of 144 cm⁻¹ and a peak intensity of 463 cm⁻¹ (the peak intensity of 144 cm⁻¹÷the peak intensity of 463 cm⁻¹), the ratio of the peak intensity of 144 cm⁻¹ and a peak intensity of 635 cm⁻¹ (the peak intensity of 144 cm⁻¹÷the peak intensity of 653 cm⁻¹), and the ratio of the peak intensity of 463 cm⁻¹ and the peak intensity of 635 cm⁻¹ (the peak intensity of 463 cm⁻¹÷the peak intensity of 635 cm⁻¹), if the relationship between the peak intensity ratios and the content of the T′ phase is arranged, a linear relationship as shown in FIG. 10 is obtained.

In this embodiment, measurement based on the Raman spectroscopy is performed with respect to test pieces for which the content of the T′ phase is known by the X-ray diffraction and the Rietveld analysis, similar to the first embodiment. Feature amounts (peak position, full width at half maximum, and peak intensity ratio) of spectrums in measurement results are extracted, and a correlation between the extracted feature amounts and the content of the T′ phase (for example, FIGS. 8 to 10) is obtained. Further, similar to the first embodiment, the relational expression [Expression (4)] between the content of the T′ phase, the heating time, and the TBC surface temperature is obtained.

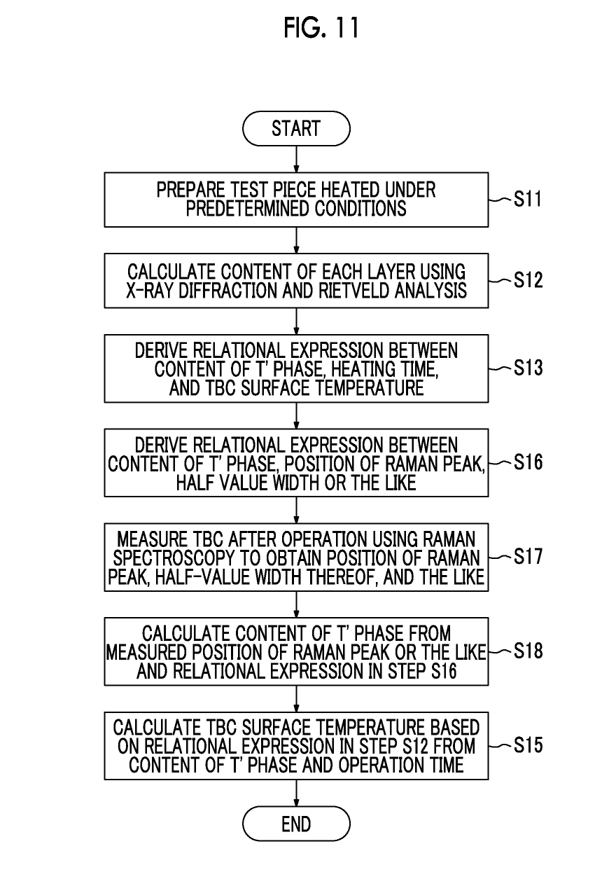

Next, a method for estimating a TBC surface temperature of a high temperature member of an actual machine according to this embodiment will be described with reference to FIG. 11.

FIG. 11 shows a flowchart of a TBC surface temperature estimation method according to the second embodiment of the invention.

Steps S11 to S13 are processes in a preparation stage. These processes are the same as in the first embodiment. That is, test pieces are heated under various conditions to form heated test pieces (step S11), and the contents of the T phase, and the like are calculated by the X-ray diffraction and the Rietveld analysis with respect to each test piece (step S12). Then, the relational expression between the content of the T′ phase, the heating time, and the TBC surface temperature during heating is derived (step S13).

In this embodiment, then, the Raman spectroscopy is performed with respect to each test piece. In consideration of a predetermined Raman peak in a measurement result obtained by the Raman spectroscopy, a correlation between each of the position of the Raman peak, a full width at half maximum of the Raman peak and an intensity ratio of the Raman peaks, and the content of the T′ phase calculated in step S12 is arranged to calculate at least one of a relational expression between the position of the Raman peak and the content of the T′ phase (for example, FIG. 8), a relational expression between the full width at half maximum of the Raman peak and the content of the T′ phase (for example, FIG. 9), and a relational expression between the intensity ratio of the Raman peaks and the content of the T′ phase (for example, FIG. 10) for each considered Raman peak (step S16). The above processes correspond to processes in a preparation stage in this embodiment.

Then, estimation of the TBC surface temperature of the high temperature member 10 of the actual machine is performed. First, a TBC (top coat layer) which is a measurement target is obtained from a gas turbine after operation. Measurement based on the Raman spectroscopy is performed with respect to the obtained measurement target TBC. Then, at least one of a Raman peak position, a Raman peak full width at half maximum, and a peak intensity ratio is obtained with respect to the measurement target TBC from the measurement result (step S17).

Then, the Raman peak position, the Raman peak full width at half maximum, and the peak intensity ratio calculated in step S17 are substituted in a corresponding relational expression calculated in step S16 to calculate the content of the T′ phase included in the measurement target TBC (step S18). Then, the content of the T′ phase calculated in step S18 and the operation time of the gas turbine which is already known are substituted in the relational expression [for example, Expression (4)] between the content of the T′ phase, the heating time, and the TBC surface temperature calculated in step S13. The expression after substitution is solved for the TBC surface temperature (T) to calculate the TBC surface temperature (step S15). The calculated value is an estimated value of the TBC surface temperature during heating according to this embodiment.

In the first embodiment, the Rietveld analysis is performed to calculate the content of the T′ phase included in the top coat layer 14 of the actual machine. Generally, the Rietveld analysis takes time and labor. On the other hand, in this embodiment, the content of the T′ phase included in the top coat layer 14 of the actual machine is calculated by using the Raman spectroscopy capable of being relatively easily performed by any operator, instead of the X-ray diffraction and the Rietveld analysis. Accordingly, if the preparation stage is completed, it is possible to relatively easily obtain the content of the T′ phase. Further, if the content of the T′ phase is obtained, it is possible to calculate the TBC surface temperature, similar to the first embodiment. Accordingly, according to this embodiment, it is possible to more conveniently estimate the surface temperature of the TBC regardless of an individual's skill, in addition to the effects of the first embodiment.

The Raman spectroscopy is applicable without being limited by shapes of test pieces, and a portable Raman spectroscopy device may be provided. For example, Raman spectroscopy measurement may be performed with respect to a turbine wing in a state where the device is mounted on an actual machine.

### Third Embodiment

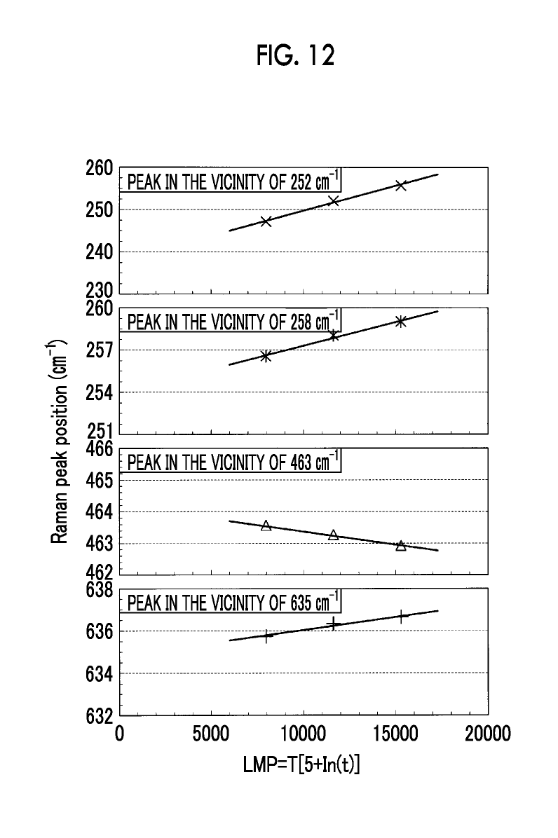

Further, the TBC surface temperature may be estimated by the following method. An estimation method of a surface temperature according to a third embodiment will be described with reference to FIGS. 12 to 14.

First, heating is performed with respect to test pieces of the top coat layer 14 under various conditions, similar to the first embodiment. Then, measurement based on the Raman spectroscopy is performed with respect to the heated test pieces. Then, a Raman spectrum obtained from the measurement is fitted by a Gaussian function and a Lorentz function to obtain a Raman peak position, a full width at half maximum, and a peak intensity. Thereafter, each of the Raman peak position, the full width at half maximum, and the intensity, a heating time, and a heating temperature are arranged using a Larson-Miller parameter (LMP=T[5+ln(t)]).

FIGS. 12 to 14 show examples of results obtained by arranging measurement values obtained based on the Raman spectroscopy using actual test pieces, using the LMP (T: heating temperature, t: heating time).

FIG. 12 is a diagram illustrating the relationship between a Raman position and an LMP value according to the third embodiment.

In FIG. 12, a longitudinal axis represents a Raman position, and a transverse axis represents an LMP value (=T [5+ln(t)]). In consideration of Raman peaks which are positioned in the vicinity of 252 cm⁻¹, 258 cm⁻¹, 463 cm⁻¹, and 635 cm⁻¹, if the relationship between these Raman peaks and the LMP value is arranged, a linear relationship as shown in FIG. 12 is obtained.

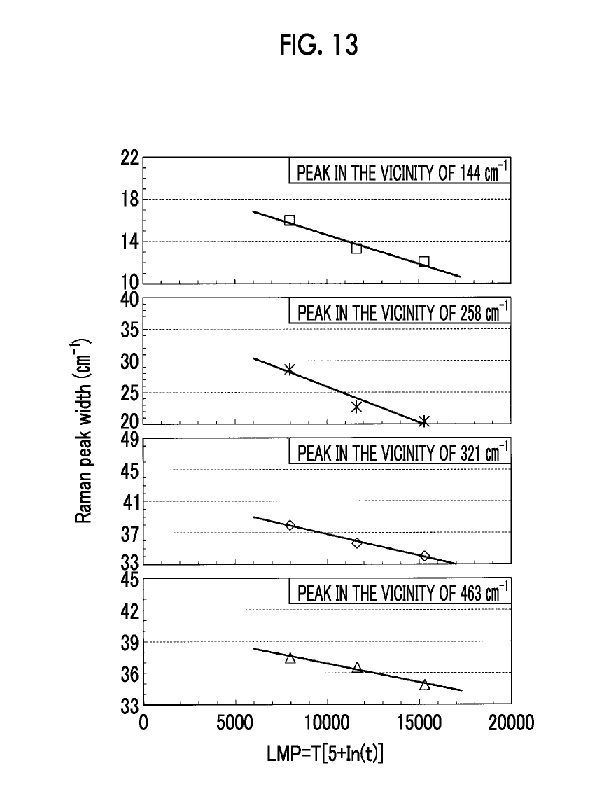

FIG. 13 is a diagram illustrating the relationship between a full width at half maximum of a Raman peak and an LMP value according to the third embodiment.

In FIG. 13, a longitudinal axis represents a full width at half maximum of a Raman peak, and a transverse axis represents an LMP value. In consideration of Raman peaks which are positioned in the vicinity of 144 cm⁻¹, 258 cm⁻¹, 321 cm⁻¹, and 463 cm⁻¹, if the relationship between these Raman peaks and the LMP value is arranged, a linear relationship as shown in FIG. 13 is obtained.

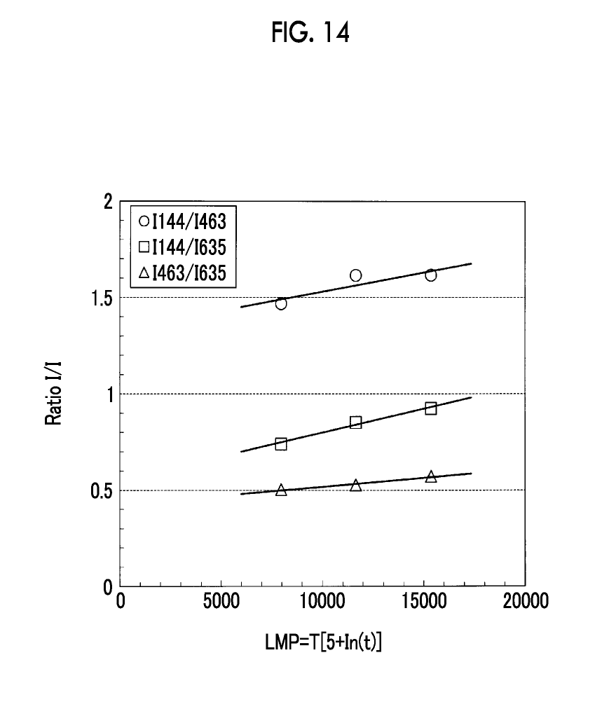

FIG. 14 is a diagram illustrating the relationship between the intensity ratio of Raman peaks and an LMP value according to the third embodiment.

In FIG. 14, a longitudinal axis represents the intensity ratio of Raman peaks, and a transverse axis represents an LMP value. In consideration of the ratio of a peak intensity of 144 cm⁻¹ and a peak intensity of 463 cm⁻¹, the ratio of the peak intensity of 144 cm⁻¹ and a peak intensity of 635 cm⁻¹, and the peak intensity of 463 cm⁻¹ and the peak intensity of 635 cm⁻¹, if the relationship between the peak intensity ratios and the LMP value is arranged, a linear relationship as shown in FIG. 14 is obtained.

The relationship between the results obtained by measuring based on the Raman spectroscopy using the test pieces and the LMP value is recorded. The above processes correspond to processes in a preparation stage.

Then, a TBC surface temperature of an actual machine is estimated. First, similar to the first and second embodiments, a TBC which is a measurement target is obtained, and measurement based on the Raman spectroscopy is performed with respect to the measurement target TBC. Then, at least one of a Raman peak position, a Raman peak full width at half maximum, and a peak intensity ratio with respect to the measurement target TBC is obtained from the measurement result. Then, in a case where the Raman peak position is obtained, the LMP value of the measurement target TBC is obtained from the relationship illustrated in FIG. 12. Similarly, in a case where the Raman peak full width at half maximum is obtained, the LMP value of the measurement target TBC is obtained from the relationship illustrated in FIG. 13. In a case where the peak intensity is obtained, the LMP value of the measurement target TBC is obtained from the relationship illustrated in FIG. 14. Then, the operation time (t) of the gas turbine is substituted in the following expression.

T×[5+ln(t)]=LMP value obtained based on FIGS. 12 to 14 (5)

By solving Expression (5) for T, it is possible to calculate a TBC surface temperature according to the third embodiment.

However, it is known that the content of the T′ phase is in high correlation with durability against the heat cycle (R. A. Miller et al., American Ceramic Society Bulletin, 62(12), 1355, 1983). By using this characteristic and the measurement method of the content of the T′ phase according to each of the first to third embodiments, it is possible to determine deterioration of the high temperature member 10.

For example, a test piece for a heat-resistant test in which the same TBC as in an actual machine is formed on the same base material as in the actual machine is prepared, and the same thermal load as in a turbine member of the actual machine is applied to the test piece, to thereby check a deterioration degree of the test piece. For example, Japanese Patent No. 4388466 discloses a method for repeatedly applying a predetermined thermal load to a test piece and evaluating the number of times of repetition at the time when peeling of TBC occurs as a heat cycle lifetime, by a laser type heat cycle tester that heats a TBC side of the test piece using laser light and cools a base material on a rear side of the test piece (on a side opposite to the side where the TBC is provided) using a cooling gas. For example, the thermal load is repeatedly applied to the test piece for the heat-resistant test until the peeling of the TBC occurs. Here, similar to the first embodiment, for each predetermined number of times of repetition, the X-ray diffraction and the Rietveld analysis are performed with respect to the test piece to calculate the content of the T′ phase included in the TBC of the test piece. Alternatively, similar to the second embodiment, using the measurement result of the Raman spectroscopy for the TBC of the test piece and the relational expression obtained in step S16, the content of the T′ phase included in the TBC of the test piece is calculated. Further, a relationship between the number of times of repetition and the deterioration degree is defined from the number of times of repetition when the peeling of the TBC occurs (for example, if the TBC is peeled by 100 times of repetition, the deterioration degree may be set to 50% in the case of 50 times of repetition), and then, a correspondence relationship between the content of the T′ phase and the deterioration degree is recorded.

Then, a TBC which is a measurement target is obtained from the actual machine, and the content of the T′ phase of the measurement target TBC is calculated using the same method as in the first embodiment or the second embodiment. Then, it is possible to determine a deterioration degree of a turbine member of the actual machine based on the correspondence relationship between the content of the T′ phase and the deterioration degree which is prepared in advance using the test piece for the heat-resistant test.

In the first to third embodiments, an example in which the YSZ is used as the material of the top coat layer 14 is shown, but the invention is not limited thereto. In addition, stabilized zirconia (for example, YbSZ, or the like) that includes one type or two or more types of oxides (alkaline such as MgO or CaO, light rare earth such as Sc₂O₃ or Y₂O₃, or heavy rare earth such as La₂O₃, Ce₂O₃, Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, or Lu₂O₃) capable of partially stabilizing zirconia (ZrO₂) may be used.

In addition, the components in the above-described embodiments may be appropriately replaced with known components in a range without departing from the spirit of the invention. Further, a technical scope of the invention does not only include the above-described embodiments, but may also include various modifications in a range without departing from the spirit of the invention. In the above description, the test piece of the top coat layer 14 is an example of a test member, and the measurement target TBC is an example of a measurement member.

### INDUSTRIAL APPLICABILITY

According to the above-described temperature estimation method, it is possible to estimate a surface temperature of a high temperature member.

### REFERENCE SIGNS LIST

1 Turbine wing
10 High temperature member
11 Base material
12 Thermal barrier coating layer
13 Bond coat layer
14 Top coat layer

1. A temperature estimation method comprising the steps of:
measuring a content of a tetragonal-prime phase included in a coating layer formed on a surface of a high temperature member by X-ray diffraction or Raman spectroscopy; and
estimating a surface temperature of the high temperature member based on the estimated content of the tetragonal-prime phase.

2. The temperature estimation method according to claim 1, further comprising the steps of:
performing Rietveld analysis with respect to each of diffraction results obtained by performing measurement based on the X-ray diffraction with respect to a plurality of test members of the coating layer heated at each of a plurality of predetermined heating temperatures for a plurality of predetermined heating times and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of test members, accumulating data on a heating temperature, a heating time, and the content of the tetragonal-prime phase corresponding to each test member, and calculating a relational expression between the heating time, the heating temperature, and the content of the tetragonal-prime phase for the test member;
performing, when the heating time in the heating is known with respect to a measurement member of the coating layer heated at a heating temperature of a predetermined temperature or higher, the Rietveld analysis with respect to the diffraction results based on the X-ray diffraction with respect to the measurement members and the diffraction result based on the X-ray diffraction with respect to the member for which the contents of the tetragonal-prime phase, the tetragonal phase, and the cubic phase are known to in advance calculate the content of the tetragonal-prime phase included in each measurement member; and
calculating the heating temperature of the measurement member based on the heating time of the measurement member, the calculated content of the tetragonal-prime phase included in the measurement member, and the relational expression.

3. The temperature estimation method according to claim 1, further comprising the steps of:
performing Rietveld analysis with respect to each of diffraction results obtained by performing measurement based on the X-ray diffraction with respect to a plurality of test members of the coating layer heated at each of a plurality of predetermined heating temperatures for a plurality of predetermined heating times and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of test members, accumulating data on a heating temperature, a heating time, and the content of the tetragonal-prime phase corresponding to each test member, and calculating a relational expression between the heating time, the heating temperature, and the content of the tetragonal-prime phase for the test member;
calculating a correlation between a feature amount of a spectrum which is a result obtained by measuring the plurality of test members using the Raman spectroscopy and the calculated content of the tetragonal-prime phase included in each test member;
calculating, when the heating time in the heating is known with respect to the measurement member of the coating layer heated at a heating temperature of a predetermined temperature or higher, the content of the tetragonal-prime phase included in the measurement member based on the feature amount of the spectrum obtained by measuring the measurement member using the Raman spectroscopy and the correlation; and
calculating the heating temperature of the measurement member based on the heating time of the measurement member, the calculated content of the tetragonal-prime phase included in the measurement member, and the relational expression.

4. The temperature estimation method according to claim 2,
wherein the relational expression is based on a linear relationship between a decomposition amount of the tetragonal-prime phase and ¼ powers of the heating time.

5. A content measurement method of a tetragonal-prime phase, for measuring a content of a tetragonal-prime phase included in a coating layer formed on a surface of a high temperature member, comprising the step of:
performing Rietveld analysis with respect to each of diffraction results obtained by performing measurement based on X-ray diffraction with respect to the measurement members of the coating layer heated at a heating temperature of a predetermined temperature or higher and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of measurement members.

6. A content measurement method of a tetragonal-prime phase, for measuring a content of a tetragonal-prime phase included in a coating layer formed on a surface of a high temperature member, comprising the steps of:
performing Rietveld analysis with respect to each of diffraction results obtained by performing measurement based on the X-ray diffraction with respect to a plurality of test members of the coating layer heated at each of a plurality of predetermined heating temperatures for a plurality of predetermined heating times and a diffraction result obtained by performing measurement based on the X-ray diffraction with respect to a member for which contents of a tetragonal-prime phase, a tetragonal phase, and a cubic phase are known in advance to calculate the content of the tetragonal-prime phase included in each of the plurality of test members;
calculating a correlation between a feature amount of a spectrum which is a result obtained by measuring the plurality of test members using the Raman spectroscopy and the calculated content of the tetragonal-prime phase included in each test member; and
calculating, when the heating time in the heating is known with respect to the measurement member of the coating layer heated at a heating temperature of a predetermined temperature or higher, the content of the tetragonal-prime phase included in the measurement member based on the feature amount of the spectrum obtained by measuring the measurement member using the Raman spectroscopy and the correlation.

7. A deterioration determination method comprising the steps of:
calculating the content of the tetragonal-prime phase included in the measurement member by the content measurement method of the tetragonal-prime phase according to claim 5; and
calculating a deterioration degree of the high temperature member based on a predetermined correspondence relationship between the content of the tetragonal-prime phase included in the measurement member and the deterioration degree of the high temperature member.
